(19) United States
(12) Patent Application Publication
(10) Pub. No.: US 2016/0104099 A1
(43) Pub. Date: Apr. 14, 2016

(54) SYSTEM AND METHOD FOR ENHANCING AN AUTOMATED DELIVERY SYSTEM

(71) Applicant: Daniel Villamar, N. Las Vegas, NV (US)

(72) Inventor: Daniel Villamar, N. Las Vegas, NV (US)

(21) Appl. No.: 14/728,744

(22) Filed: Jun. 2, 2015

Related U.S. Application Data
(60) Provisional application No. 62/063,385, filed on Oct. 13, 2014.
(60) Provisional application No. 62/122,313, filed on Oct. 17, 2014.

(51) Int. Cl. G06Q 10/08; G06Q 50/28; G06Q 50/30; G06Q 30/06

(52) U.S. Cl. CPC G06Q 10/083; G06Q 30/0635; G06Q 50/28; G06Q 50/30; G06Q 10/0875

(57) ABSTRACT

The present invention relates to a system and method for enhancing an automated delivery system by implementing a laser scanning mechanism. The method accepts the consumer's order over the network and instructs the delivery vehicle to collect the item(s) as per the order placed by the consumer. As the delivery vehicle receives the order from the consumer, the vehicle starts moving towards the placer robot over a guideway track to collect the ordered item(s). Further, as the delivery vehicle identifies a light emitting device (LED) over the guideway track, the delivery vehicle stops at the specified location. As the delivery vehicle stops at the specified location, the motion detector instructs the LED device to emit a laser signal for scanning the delivery vehicle and based on the scanned information, the processing device instructs the placer robot(s) to retrieve and dispense the ordered item(s) into delivery vehicle.

### CROSS-REFERENCE TO RELATED APPLICATION

This application claims benefit of priority of U.S. Provisional Patent Application 62/063,385 filed on 13 Oct., 2014 entitled “Infrastructure and Processes for Automated Delivery” which is owned by the assignee of the present application and herein incorporated by references in its entirety

### FIELD OF THE INVENTION

The present invention generally relates to enhancing an automated delivery system and more particularly relates to enhancing the automated delivery system by using a laser scanning mechanism to detect the motion of the delivery vehicle and to dispense the selected item(s) and/or the delivery unit from the delivery vehicle.

### BACKGROUND OF THE INVENTION

Laser scanning technique is widely used in various fields for scanning the objects and determining the unique identity of these objects. Further, the technique can be easily adopted to enhance the usage of a system.

Purchasing items online over the network has increased over a period of time. An automated delivery system is implemented to simplify the online purchasing activity of a consumer, and at times it becomes an overhead for the system to identify the item(s) to be purchased from a retailer shop or any warehouse. Additionally, the system must be capable of carrying the delivery units that are filled with the items and to dispense the delivery units at the required location. In order to address these concerns, associated with the automated delivery system, it is recommended to implement the laser scanning technique in the automated delivery system to enhance the experience of online purchasing activity.

Hence, there is a need for enhancing the automated delivery system by implementing the laser scanning technique to scan the objects for delivering the item(s) and dispensing the delivery unit filled with the item(s) from the delivery vehicle.

### SUMMARY OF THE INVENTION

The present invention relates to a system and method for enhancing an automated delivery system by implementing a laser scanning mechanism, wherein the method comprises of dispensing the item(s) into a delivery vehicle based on the consumer's order and/or dispensing the delivery unit from the delivery vehicle. The method counts the number of objects placed over a guideway track to stop the delivery vehicle at the required location and collects the item(s) that is/are dispensed by the placer robot(s) based on the consumer's order. Further, the method counts the number of objects placed over the guideway track to stop the delivery vehicle at the required location to dispense the delivery unit filled with item(s) at the marketing unit.

### BRIEF DESCRIPTION OF DRAWINGS

FIG. 1 illustrates a working overview of the system 100 for enhancing an automated delivery system 100 by implementing a laser scanning mechanism.

FIG. 2 illustrates a screen-shot that depicts the placer robot(s) 105 covered with insulated material 201 to keep the stored items at a constant temperature.

FIG. 3 illustrates a screen-shot that depicts the process of dispensing the item(s) from the placer robot(s) 105 by identifying the location of the delivery vehicle 103.

FIG. 4 illustrates a screen-shot that depicts the process of identifying the motion of the delivery vehicle 103 and instructing the placer robot(s) 105 to dispense the item(s) by using the laser scanning mechanism.

FIG. 5 illustrates a screen-shot that depicts the process of identifying the counter objects placed over the guideway track 104 to stop the delivery vehicle 103 at the required location by using the laser scanning mechanism.

FIG. 6 illustrates a block diagram that explains the process of dispensing multiple items ordered by the consumer.

FIGS. 7a and 7b illustrate a side-view and a rear-view of the delivery vehicle 103 provided with the drawers to collect the dispensed items.

FIGS. 8a and 8b illustrate various types of containers 800 used to design different layout for a delivery unit 802 to collect the dispensed item(s) or to dispense the delivery unit 802 as placer robot(s).

FIG. 9 illustrates a flow-chart 900 that explains the method 900 of delivering item(s) based on the consumer's order or dispensing a delivery unit 802 as a placer robot.

FIGS. 10a and 10b illustrates the design of the delivery vehicle 103 to determine the location of the delivery vehicle 103 over the guideway track 104 and to stop the movement of the delivery vehicle 103 by using the guiding pin and a wheel button.

FIG. 11 illustrates a screen-shot of the accordion connector 1101 used for connecting a plurality of containers 800 for designing a delivery unit 802 of the delivery vehicle 103.

FIG. 12 illustrates a screen-shot that depicts the plurality of containers 800 connected by the accordion connector 1101, wherein the plurality of containers 800 is filled with the item(s) and dispensed at the placer robot(s) 105.

FIG. 13 illustrates a screen-shot that depicts the process of extracting the delivery unit 802 from the delivery vehicle 103 and positioning the delivery unit 802 as a placer robot 105.

FIG. 14 illustrates a system overview 1400 of components used for enhancing an automated delivery system 100 by implementing a laser scanning mechanism.

### FIGURE DESCRIPTION

100—An automated delivery system overview for implementing the laser scanning mechanism
101—Location of a consumer placing an order for the required items
102—Location of a store, a factory, or a warehouse for collecting the required item(s)
103—A delivery vehicle used for delivering the required item(s)
104—A guideway track over which the delivery vehicle is set in motion
105a, 105b, 105c—A collection of placer robots from which the item(s) is/are dispensed
106—The process of dispensing item(s) into the delivery vehicle
201—Insulated placer robots that are used for maintaining the temperature of the stored items constant
300—A processing device used to process the consumer's order
401—A laser emitting device (LED)
402—A motion sensor or detector
403—The process of scanning the delivery vehicle
501—A counter object used for determining the location of the delivery vehicle
501a, 501b, 501c—Counter objects placed at different locations over the guideway track
600—Depicts the process of implementing the method of laser scanning mechanism to deliver the item(s) and/or to dispense the delivery unit as placer robot(s).
701—Side-view of the delivery vehicle
702a, 702b, 702c, 702d, 702e, and 702f—Drawers placed in the delivery vehicle
703—A plurality of wheels connected to the delivery vehicle
704—A rear-view of the delivery vehicle
800—Overview of the containers
801a—Overhead view of the container
801b—Overhead view of the square container
801c—Overhead view of long rectangular container
801d—Overhead view of short rectangular container
801e, 801f, 801g, and 801h—Overhead view of square containers and a long rectangular container
801i, 801j, 801k—Overhead view of three rectangular containers placed in the form of rows
801l, 801m—Overhead view of two short rectangular containers
802—A delivery unit comprising a plurality of containers
900—Depicts the process of implementing the method of dispensing item(s) into the delivery vehicle
1011—Front view of the delivery vehicle
1012—A plurality of wheels connected to the delivery vehicle
1013—A guiding pin connected to the delivery vehicle
1014—A scroll button connected to the delivery vehicle
1015—A counter object placed inside the guiding groove
1016—A guiding groove for placing the counter object
1017—A wheel button connected to the delivery vehicle
1101—An accordion connector
1301—Empty placer robot(s)
1302—Delivery vehicle carrying the delivery unit filled with item(s)
1303—Delivery unit dispensed from the delivery vehicle
1304—Placer robot nozzle for dispensing the item(s) into the delivery vehicle

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the automated delivery system implements a laser scanning mechanism to scan the delivery vehicle's unique identifier and to instruct the placer robot(s) for dispensing the ordered item(s) in the delivery vehicle upon identifying the delivery vehicle 103 within the vicinity of the placer robot 105.

In an embodiment, the item(s) is/are ordered by a consumer through a computer network and the order is shared with the placer robot(s) 105 along with the delivery vehicle 103. The placer robot(s) 105 is/are configured at the stores, factory, or a ware house to retrieve and dispense the item(s) ordered by consumer. Hence, throughout the document, the term placer robot(s) 105 is/are commonly used for referring to the terms such as stores, factory, or ware house from where the item(s) are retrieved.

In an embodiment, the term counter object refers to an object that is used to determine the location of the delivery vehicle 103 based on which the placer robot(s) 105 is/are triggered to retrieve the item(s) and to dispense the retrieved item(s) as the delivery vehicle 103 arrives at the specified placer robot(s) 105. Additionally, the delivery vehicle 103 can dispense the container(s), filled with item(s), at the marketing unit.

In an embodiment, the marketing unit can be considered to be a retailer shop, a wholesale market, a trading unit, a sales unit, a placer robot, or the like that provides an order for dispensing the delivery unit filled with the required goods or items.

In an embodiment, a delivery unit refers to a structure supported in the form of drawers or box cart that can be used to collect the items in the delivery vehicle 103 and to dispense the items from the delivery vehicle 103. The delivery unit structure can be in the form drawers and/or a box cart.

In an embodiment, the term Item holder refers to a plurality of containers designed and placed inside the drawers for collecting the items in the delivery vehicle 103.

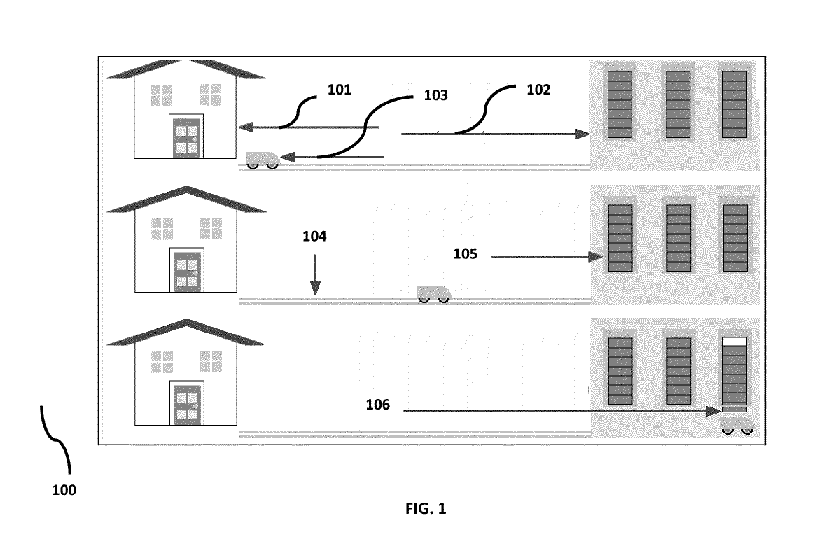

Referring to FIG. 1 illustrates a working overview of the system 100 for enhancing an automated delivery system 100 by implementing a laser scanning mechanism. As depicted in the figure, a consumer places his/her order 101 through the internet and as the consumer places the order 101, a delivery vehicle 103 waiting at the consumer's location is configured to receive the order 101. Upon the receiving the consumer's location, the delivery vehicle 103 starts moving towards the placer robot 105. In an embodiment, the delivery vehicle 103 is configured to move over the guideway track 104 to reach the placer robot(s) 105 and to collect the ordered items from the placer robot(s) 105. In an embodiment, the placer robot(s) 105 is/are configured to identify the delivery vehicle 103 that arrives at the location of a placer robot 105 (by using a laser scanning mechanism) and upon identifying the delivery vehicle 103, the placer robot(s) 105 is/are configured to retrieve the item(s) and dispense the retrieved item(s) into the delivery vehicle 103. In an embodiment, each of the placer robots 105 is configured to dispense a single type of item into the delivery vehicle 103. Further, as the delivery vehicle 103 collects the required item(s) from the placer robot(s) 105, the vehicle 103 moves back towards the consumer's destination.

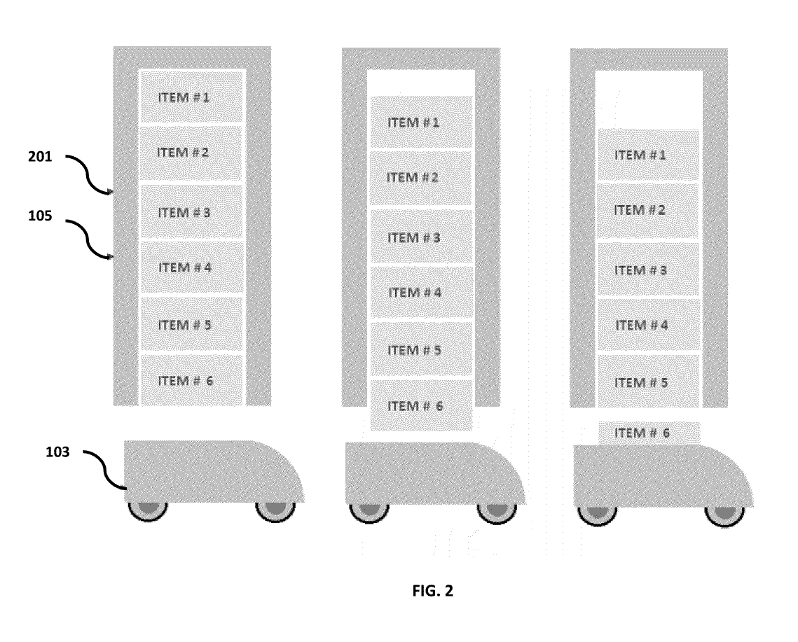

Referring to FIG. 2 illustrates a screen-shot that depicts the placer robot(s) 105 covered with insulated material 201 to keep the stored items at a constant temperature. In an embodiment, energy can be used to heat or cool the placer robot 105 interior containers so that the retail goods or items inside the dispensing unit can be stored at an ideal warm or cool temperature.

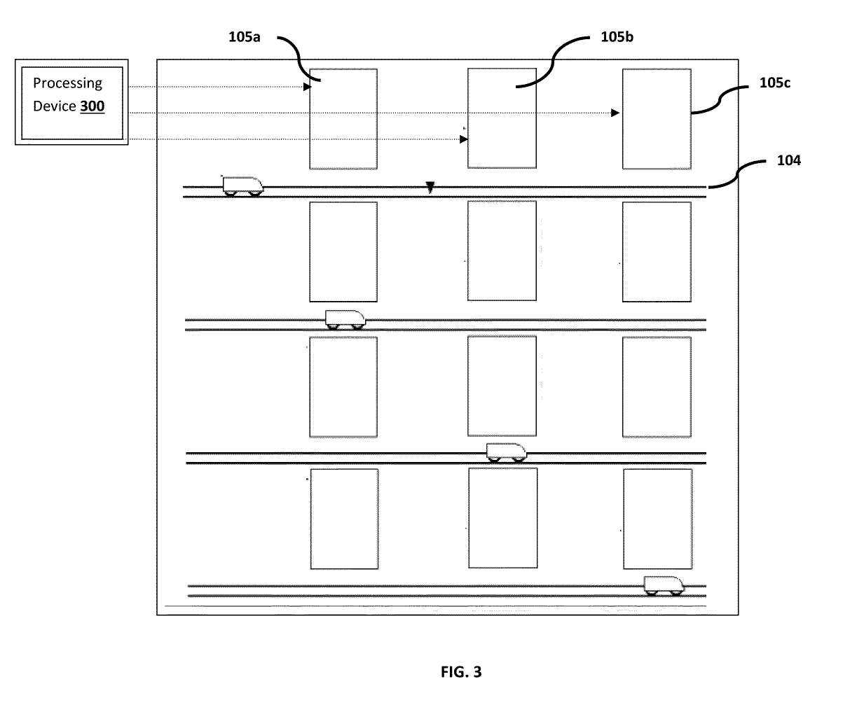

Referring to FIG. 3 illustrates a screen-shot that depicts the process of dispensing the item(s) from the placer robot(s) 105 by identifying the location of the delivery vehicle 103. In an embodiment, as the delivery vehicle 103 approaches the placer robot(s) 105, the processing device 300 sends a signal to the placer robot(s) 105 to dispense the item(s), ordered by the consumer, into the delivery vehicle 103. For example, as the delivery vehicle 103 approaches the placer robot 105a, the processing device 300 sends a signal to the placer robot 105a to dispense a cereal package into the delivery vehicle 103. The delivery vehicle 103 collects the dispensed item(s) and moves towards the next placer robot 105b. Further, as the delivery vehicle 103 arrives at the placer robot 105b, the processing device 300 sends a signal to the placer robot 105b to dispense milk packet(s) into the delivery vehicle 103. Upon collecting the dispensed item(s) from the placer robot 105b, the delivery vehicle 103 moves towards the placer robot 105c. Further, as the delivery vehicle 103 arrives at the placer robot 105c, the processing device 300 sends a signal to the placer robot 105c to dispense bread packet(s) into the delivery vehicle 103. Upon collecting the dispensed item(s) from the placer robots 105a, 105b, and 105c, the delivery vehicle 103 returns towards the consumer's destination.

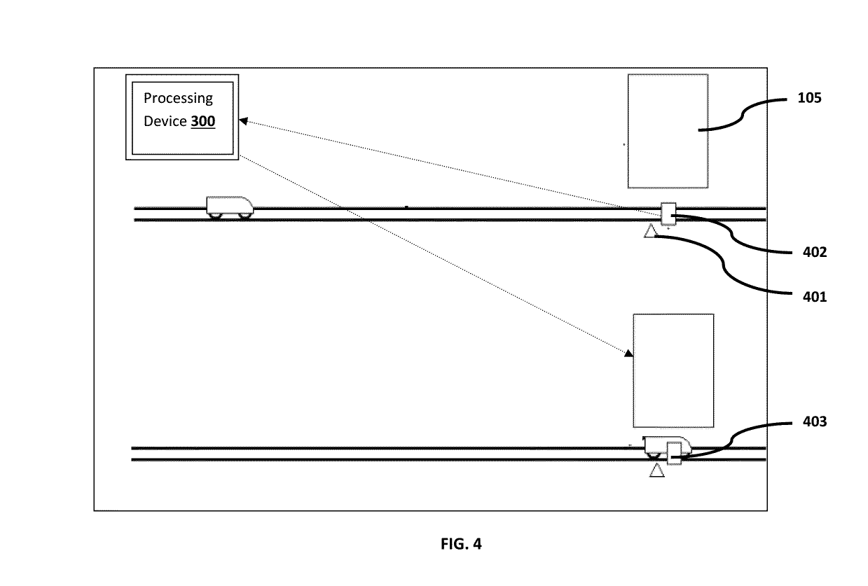

Referring to FIG. 4 illustrates a screen-shot that depicts the process of identifying the motion of the delivery vehicle 103 and instructing the placer robot(s) 105 to dispense the item(s) by using the laser scanning mechanism. In an embodiment, as the delivery vehicle 103 approaches the placer robot 105, the delivery vehicle 103 identifies a Light Emitting Device (LED) 401 over the guideway track 104 and stops at the location where the LED device 401 is identified. Further, as the delivery vehicle 103 stops at the LED device 401, a motion detector 402 placed in front of each placer robot 105 is configured to detect the movement of the delivery vehicle 103 over the guideway track 104. In an embodiment, as the motion detector 402 detects that the delivery vehicle 103 has stopped in front of the placer robot 105, the motion detector 402 sends a signal to the LED device 401 to emit a laser signal for scanning the unique identifier of the delivery vehicle 103. For example, the laser signal can scan the QR code or a bar code attached to the delivery vehicle 103. Upon identifying the delivery vehicle 103 by scanning the unique identifier 403 using the laser signal, the processing device 300 is configured to receive the delivery vehicle 103 related information. In an embodiment, the delivery vehicle 103 related information comprises of information related to the item(s) that are ordered by the consumer, the destination address, the travelling time preferred for delivering the ordered item(s), and any other information associated with the consumer's delivery order. Upon receiving the delivery vehicle 103 related information, the processing device 300 determines that the delivery vehicle 103 has stopped at the placer robot 105 and sends a signal to the placer robot 105 for dispensing the item(s) ordered by the consumer. Upon receiving the signal from the processing device 300, the placer robot(s) is/are configured to dispense the item(s) to the delivery vehicle 103 as per the information provided by the processing device 300.

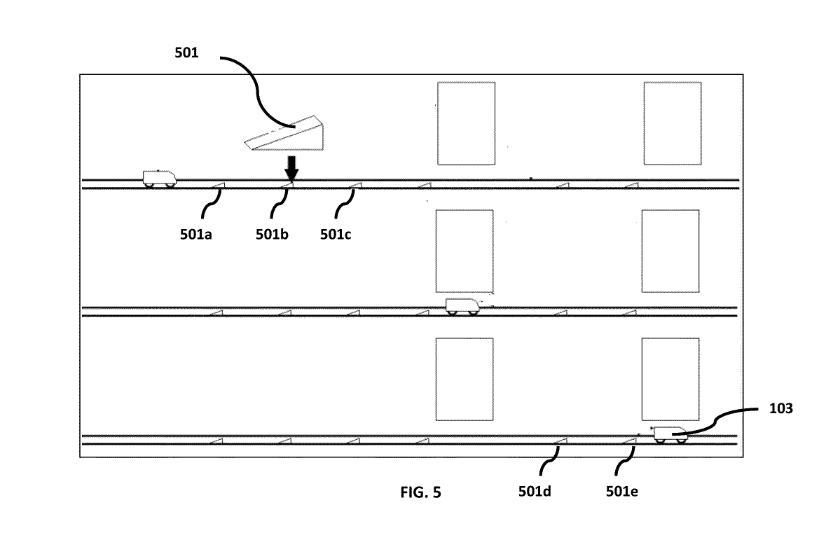

Referring to FIG. 5 illustrates a screen-shot that depicts the process of identifying the counter objects placed over the guideway track 104 to stop the delivery vehicle 103 at the required location by using the laser scanning mechanism. In an embodiment, the processing device 300 is configured to instruct the delivery vehicle 103 to stop after the delivery vehicle 103 has counted, passed, and recorded a desired number of counter objects 501a, 501b, 501c placed over the guideway track 104. For example, as depicted in the figure, the delivery vehicle 103 is instructed to stop after the vehicle 103 has counted, passed, and recorded four counter objects over the guideway track 104. In the second instance, the delivery vehicle 103 is instructed to stop after the vehicle 103 has counted, passed, and recorded the fifth and sixth counter objects (501d and 501e) over the guideway track 104.

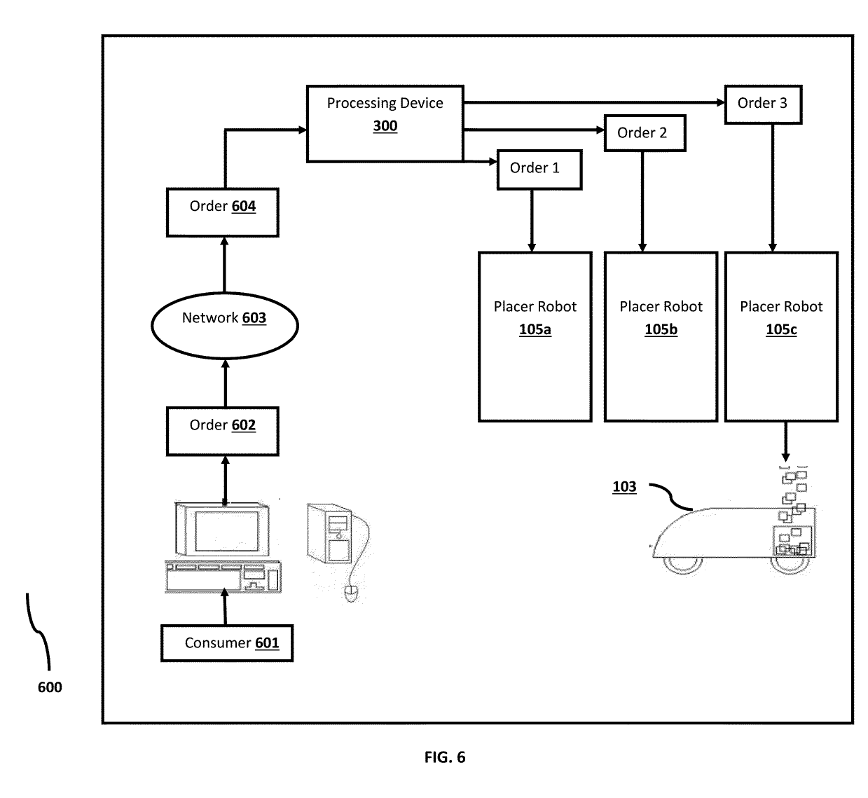

Referring to FIG. 6 illustrates a block diagram 600 that explains the process of dispensing multiple items ordered by the consumer. As depicted in the figure, the consumer 601 provides his/her order 602 for purchasing the item(s) through the network 603 such as an internet. In an embodiment, the order 604 provided by the consumer 601 is processed by the processing device 300 and the processing device 300 is configured to share the order information with the placer robots 105a, 105b, and 105c to dispense multiple items from the placer robots 105a, 105b, and 105c to the delivery vehicle 103 as the delivery vehicle 103 arrives at the placer robots. In an embodiment, as the delivery vehicle 103 arrives at the placer robot 105a, the LED device sends a laser signal to the processing device 300 indicating that the delivery vehicle 103 has arrived at the placer robot 105a. Upon receiving the laser signal, the processing device 300 is configured to send the order information 604 to the placer robot 105a for retrieving the item ordered by the consumer 601 and dispensing the ordered item into the delivery vehicle 103. The process repeats until all the items ordered by the consumer 601 are retrieved and dispensed from the placer robots 105b, 105c into the delivery vehicle 103.

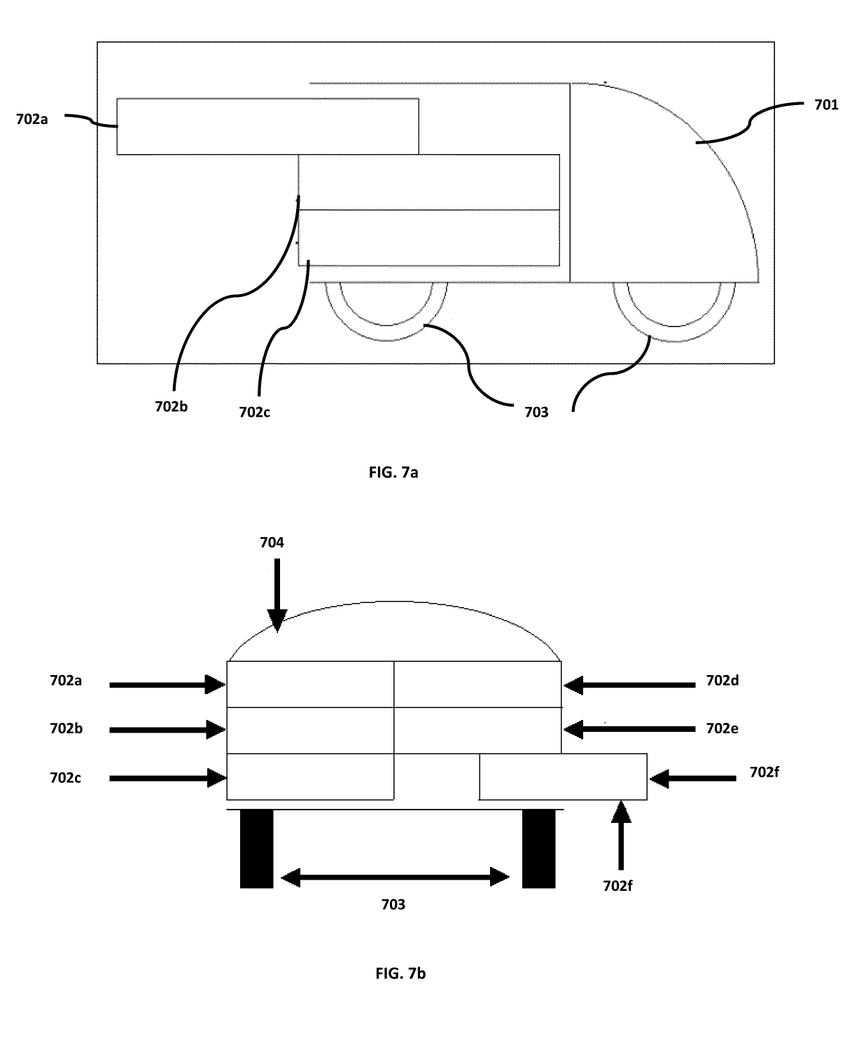

Referring to FIGS. 7a and 7b illustrates a side-view and a rear-view of the delivery vehicle 103 provided with the drawers to collect the dispensed items. As depicted in FIG. 7a, the side-view 701 of the delivery vehicle 103 displays multiple drawers 702a, 702b, and 702c placed one above the other to collect the retrieved items from the placer robot 105. The drawers can be slided-out from the back of the delivery vehicle 103 to collect the item(s) from the placer robot 105. Further, the delivery vehicle 103 is attached with a plurality of wheels 703 that moves over the guideway track 104. In another embodiment, the drawers 702a, 702b, 702c, 702d, 702e, 702f of the delivery vehicle 103 can be placed side-ways at the rear-side 704 of the delivery vehicle 103 as shown in the FIG. 7b, and the drawers can be pulled towards the side-ways to fill in the items dispensed from the placer robot(s) 105.

A delivery vehicle 103 can be owned by a consumer or by a business unit, in which case the goods or items can be delivered directly to the consumer from the business unit. While delivering the item(s), the drawers can be locked by the business unit. In an embodiment, to unlock the locked drawer or box cart of the delivery vehicle 103, it may be necessary for the consumer to use a permanent password, or a one-time password that could be assigned to consumer over the internet before, during, or after the consumer placed the order. In other embodiments, the consumer may also open a locked drawer with a key, a card key, scannable card, or using other objects, which functions as a key. The consumer may receive the instruction to choose the locking and unlocking mechanism for drawers on a screen such as a computer monitor screen, a cell phone screen, or a tablet screen.

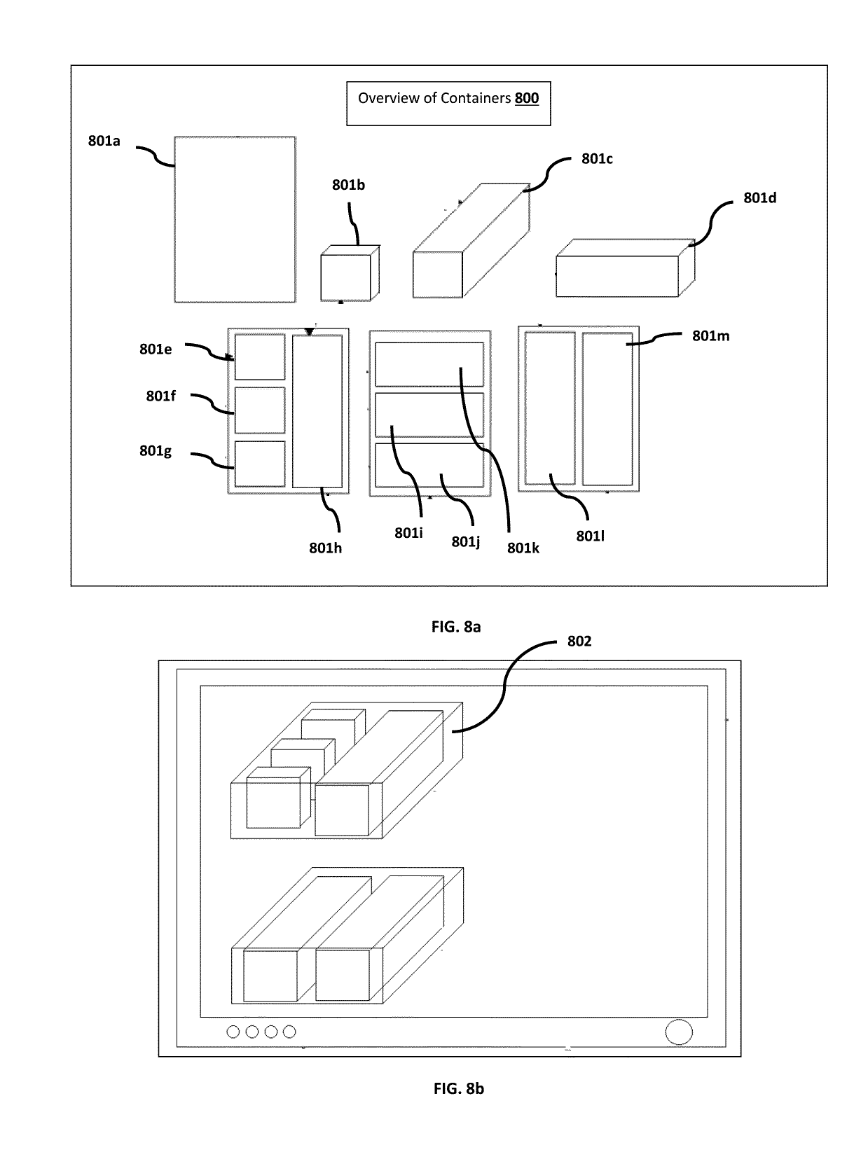

Referring to FIGS. 8a and 8b illustrates various types of containers 800 used to design different layouts for a delivery unit 802 to collect the dispensed item(s) or to dispense the delivery unit 802 as placer robot(s) 105. As depicted in the FIG. 8a, the container(s) 800 can be designed in various forms and shapes to fill in the item(s), and/or can be dispensed as a delivery unit 802 by the delivery vehicle 103. For example, the container design includes but not limited to a square container 801b, a long rectangular container 801c, a short rectangular container 801d, a combination of square and rectangular containers 801e, 801f, 801g, and 801h, rectangular containers arranged in the form of rows 801i, 801j, and 801k, two rectangular containers 801l and 801m placed next to each other. Further, as shown in FIG. 8b, the delivery unit 802 can comprise of one or more drawers or box cart(s) filled with various container(s) to collect the dispensed item(s) from the placer robot(s) 105. In an embodiment, the delivery unit 802 can be extracted by the placer robot(s) to behave as placer robot(s) 105 for dispensing the item(s) from the delivery unit 802 into the delivery vehicle 103. In an embodiment, the delivery unit 802 can be lifted off the delivery vehicle 103 manually by a plurality of humans and/or robots and then loaded onto a placer robot 105 where the delivery unit 802 will function as the placer robots 105 dispensing unit. In an embodiment, a container constructed of an insulative material can function as the dispensing unit of the placer robot 105.

In an embodiment, as the consumer places an order over the internet, the consumer can be instructed over the internet through illustrative, and/or text and/or auditory means regarding the number of containers, the size of containers, the shape of containers, and the layout designs to arrange the containers within a drawer of the delivery vehicle 103.

For example, in one embodiment as the consumer places an order over the internet, the consumer will be able to see the drawing on the consumer's monitor, cell Phone, or tablet screen that instructs the consumer about the layout design of the containers to be used within the delivery vehicle 103. Written words and/or voice instructions can also be used to inform the consumer about the layout design of containers to be placed in the delivery vehicle 103.

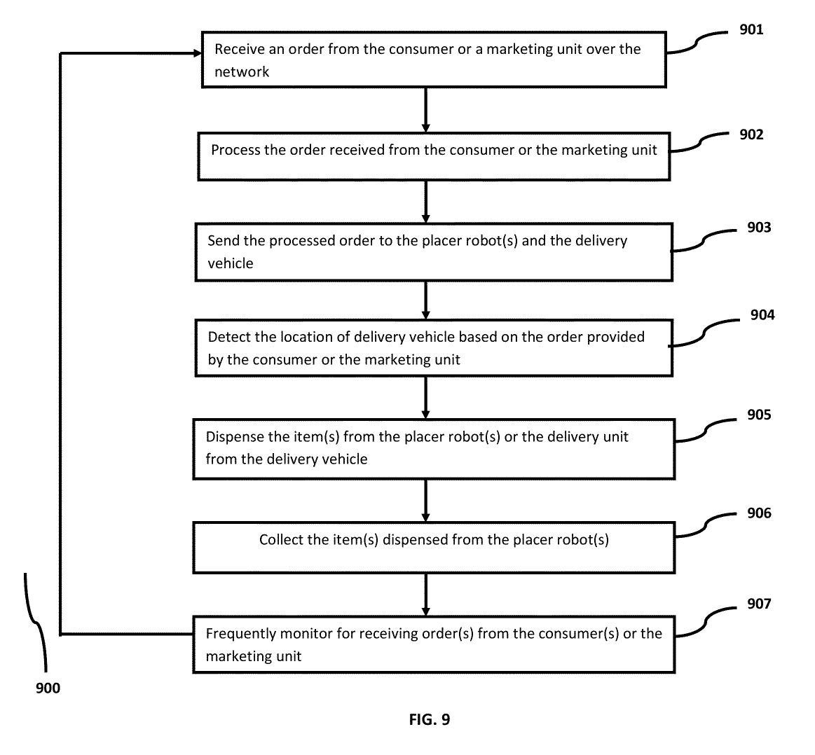

Referring to FIG. 9 illustrates a flow-chart 900 that explains the method 900 of delivering item(s) based on the consumer's order or dispensing a delivery unit 802 as a placer robot. Initially, at step 901, the processing device 300 receives an order from the consumer(s) 601 or a marketing unit through the network. Further, at step 902, the order received from the consumer 601 or the marketing unit is processed by the processing device 300. At step 903, the processed order is sent to the placer robot(s) 105 when the delivery vehicle 103 arrives at the placer robot 105 over the guideway track. At step 904, as the delivery vehicle 103 arrives at the placer robot 105, the LED device detects the location of the delivery vehicle and sends a laser signal to the processing device 300. As the processing device 300 receives the laser signal, at step 905, the processing device 300 sends the consumer's order and instructs the placer robot(s) 105 to dispense the item(s) into the delivery vehicle 103.

In an embodiment one or a plurality of mechanical arms located at the bottom of the placer robot(s) can catch, or pick an item to place the item into the delivery vehicle 103. In yet another embodiment, a retail item that is available in the placer robots 105 dispensing unit can be held by a mechanical contraption and the mechanical contraption can than place the item inside the delivery vehicle 103.

Optionally, the processing device 300 instructs the delivery vehicle 103 to dispense the delivery unit(s) 802 at the placer robot(s) based on the order provided by the marketing unit. Further, the delivery unit(s) 802 can be used to dispense the item(s) based on the consumer's order. At step 906, the dispensed item(s) can be collected in the delivery vehicle 103 and sent to the consumer's destination over the guideway track. At step 907, the method 900 frequently monitors to receive order(s) placed by the consumer(s) and/or the marketing unit.

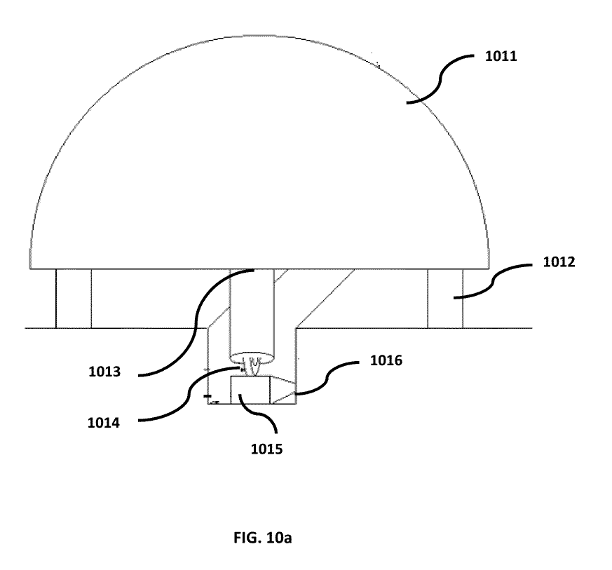

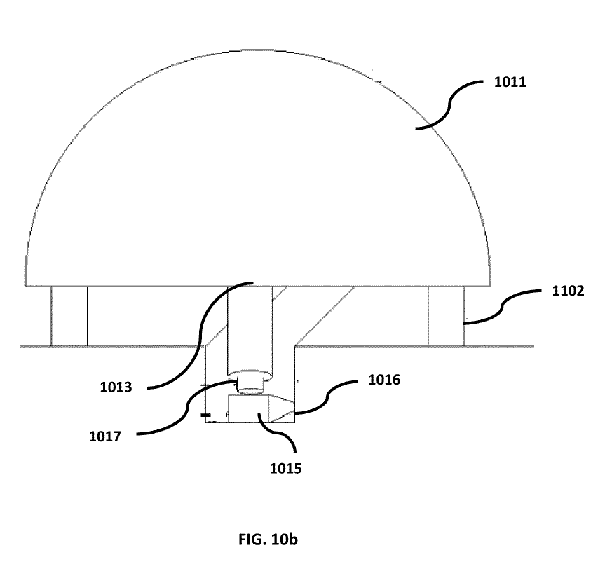

Referring to FIGS. 10a and 10b illustrates the design of the delivery vehicle 103 to determine the location of the delivery vehicle 103 over the guideway track 104 and to stop the movement of the delivery vehicle 103 by using the guiding pin and a wheel button. As depicted in the figure, the front-view 1011 of the delivery vehicle 103 comprises of: a plurality of wheels 1012 connected at the adjacent sides of the delivery vehicle 103, a guiding pin 1013 extending from the center of the delivery vehicle 103, a wheel attached at the bottom of the guiding pin 1013, a counter object 1015 placed inside the guiding groove 1016. In an embodiment, the guiding pin 1013 can be constructed in various shapes such as rectangular shape, a cylindrical shape, a cube shape, a square shape or the like, and a scroll button 1014 or a wheel button 1017 is attached at the bottom of the guiding pin 1013. In an embodiment, the scroll button 1014 or the wheel button 1017 is pushed inside the guiding pin 1013 as the button 1014, 1017 gets in contact with the counter object 1015. Further, as the button 1014, 1017 is pushed inside the guiding pin 1013, the processing device 300 records the count of the object crossed by the delivery vehicle 103 over the guideway track 104.

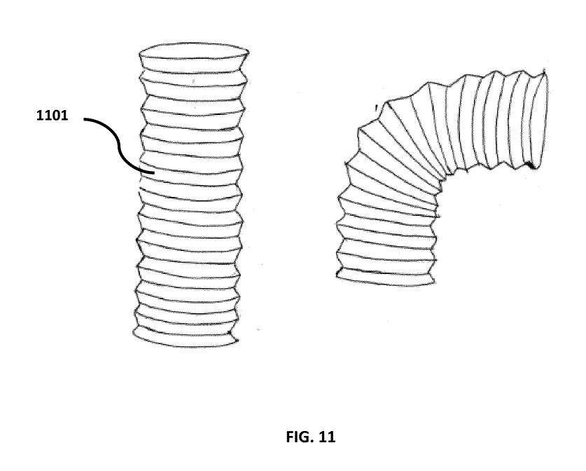

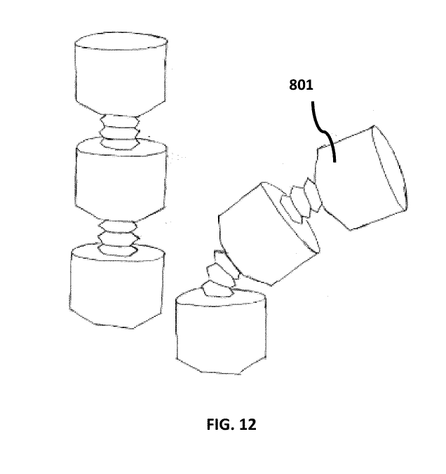

Referring to FIG. 11 illustrates a screen-shot of the accordion connector 1101 used for connecting a plurality of containers 801 for designing a delivery unit 802 of the delivery vehicle 103.

Referring to FIG. 12 illustrates a screen-shot that depicts the plurality of containers 801 connected by the accordion connector 1101, wherein the plurality of containers 801 can be filled with the item(s) and/or dispensed at the marketing unit(s).

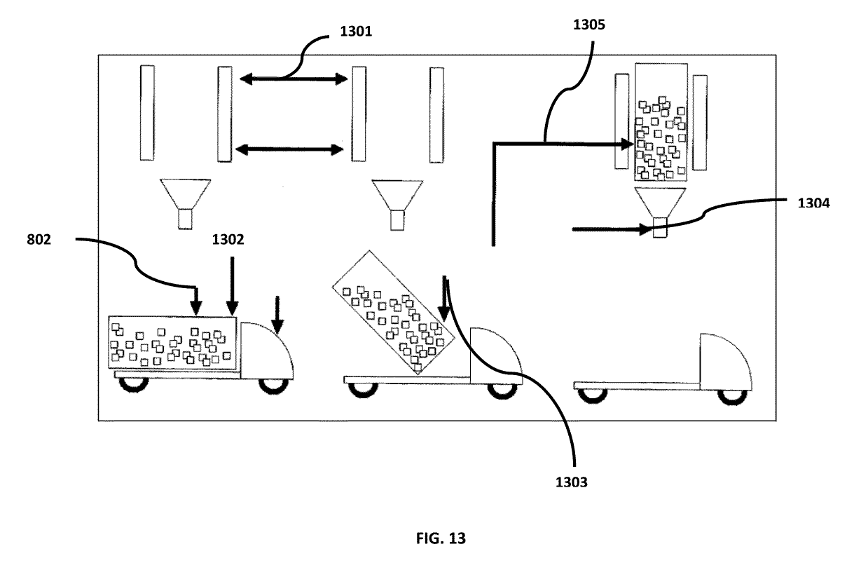

Referring to FIG. 13 illustrates a screen-shot that depicts the process of extracting the delivery unit 802 from the delivery vehicle 103 and positioning the delivery unit 802 as a placer robot 105. As depicted in the figure, the placer robots 105 are initially empty 1301. As per the order placed by the marketing unit, the delivery vehicle 103 is loaded with the delivery unit 802 containing the items as per the marketing unit's order. The delivery vehicle 103 moves over the guideway track 104 to dispense the delivery unit 802 at the required placer robots 105 location. In an embodiment, the processing device 300 instructs or sends a signal to the delivery vehicle 103 to offload the delivery unit 802 at the placer robot 105 as the delivery vehicle 103 arrives at the placer robot 105 location. In an embodiment, the delivery unit 802 can be dispensed at the placer robot's 105 location either mechanically or physically 1303. As the delivery unit 802 is dispensed at the placer robot 105, the nozzle 1304 of the placer robot 105 can be used to release or dispense the item(s) from the placer robot 105 into the delivery vehicle 103.

In an embodiment, the placer robot 105 equipped with a nozzle attached at its bottom can extend downward in side of the delivery vehicle 103 container through shutters located on top of the containers surface and then pour a liquid or granular product into the container located on board the delivery vehicle.

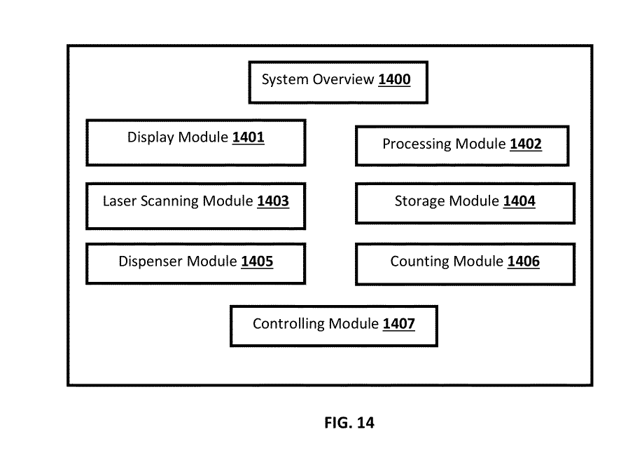

Referring to FIG. 14 illustrates a system overview 1400 of components used for enhancing an automated delivery system 100 by implementing a laser scanning mechanism, wherein the system comprises of the following components: a Display module 1401, a Processing module 1402, a Laser scanning module 1403, a Storage module 1404, a Dispenser module 1405, a Counting module 1406, and a Controlling module 1407. In an embodiment, the Display module 1401 is configured to accept the purchasing order information from the consumer through a network and is configured to display the status of the purchasing activity initiated by the consumer. In an embodiment, the Processing module 1402 is configured to process the order received from the consumer, which is referenced by the placer robot 105 for retrieving and dispensing the specified item(s). In an embodiment, the Laser scanning module 1403 is configured to scan the delivery vehicle 103 for uniquely identifying the vehicle 103 by performing a laser scan on the delivery vehicle 103. In an embodiment, the Storage module 1404 is configured to store the consumer's order information, along with the delivery vehicle 103 related information, which will be processed by the processing device 300. The processed information is used for instructing the placer robot 105 to retrieve and dispense the ordered item(s) into the container(s) of the delivery vehicle 103. In an embodiment, the Dispenser module 1405 is configured to dispense the ordered item(s) into the delivery vehicle 103 and to dispense the container(s) filled with item(s) at the marketing unit. In an embodiment, the Counting module 1406 is configured to count the number of counter objects placed over the guideway track 104 to stop the delivery vehicle 103 at the required location for collecting the dispensed item(s). In an embodiment, the Controlling module 1407 is configured to transfer data across various modules used in implementing the proposed method.

1. A method for enhancing an automated delivery system by implementing a laser scanning mechanism, wherein said method comprises of:
receiving an order provided by at least one consumer over a network;
dispensing at least one item in a delivery vehicle based on the order provided by said at least one consumer;
counting the number the objects provided over a guideway track to stop said delivery vehicle at the required location based on the order provided by said at least one consumer;
collecting said at least one item that is dispensed from at least one placer robot in said delivery vehicle, after said delivery vehicle stops at the required location over said guideway track; and
dispensing a delivery unit filled with the required item(s) based on the order provided by at least one marketing unit.

2. The method as claimed in claim 1, wherein implementing said laser scanning mechanism to dispense said at least one item in said delivery vehicle comprises of:
stopping said delivery vehicle, that is in motion over said guideway, near said at least one placer robot by identifying a laser emitting device located near said at least one placer robot;
detecting said delivery vehicle that has stopped near said at least one placer robot by using at least one motion detector;
signaling said laser emitting device to produce laser for scanning said delivery vehicle;
identifying said delivery vehicle based on the laser scanning performed; and
instructing said placer robot to release said at least one item that has been ordered by said at least one consumer over said network.

3. The method as claimed in claim 1, wherein the method of counting the number of objects to stop said delivery vehicle at the required location for collecting said at least one item comprises of:
identifying an object by said delivery vehicle that is placed over said guideway to record a count on the number of objects that has been passed by said delivery vehicle; and
instructing said delivery vehicle to stop immediately after said delivery vehicle has crossed the number of objects programmed by said laser scanning mechanism.

4. The method as claimed in claim 1, wherein said method instructs said at least one consumer to design an item holder within said delivery unit of said delivery vehicle by considering said at least one container's size, shape, layout to be placed in at least one drawer to collect said at least one item that is dispensed from said placer robot.

5. The method as claimed in claim 4, wherein said delivery unit can be structured in the form of said at least one drawer or a box cart to collect said at least one item that is dispensed from said placer robot.

6. The method as claimed in claim 4, wherein said at least one drawer of said delivery vehicle can be positioned to slide out of said delivery vehicle from side-ways or from a rear-side of said delivery vehicle.

7. The method as claimed in claim 5, wherein said method implements a locking and unlocking mechanism for said at least one drawer of said delivery vehicle while delivering said at least one item ordered by said at least one consumer.

8. The method as claimed in claim 7, wherein said method instructs said at least one consumer to implement said locking and unlocking mechanism on a display screen of said at least one consumer's device.

9. The method as claimed in claim 4, wherein said item holder can be designed by connecting a plurality of said at least one container through an accordion connector.

10. The method as claimed in claim 3, wherein identifying said object to record the count on the number of objects that has been passed by said delivery vehicle comprises of a guiding pin and a wheel button.

11. The method as claimed in claim 10, wherein said method determines the count on the number of objects that has been passed by said delivery vehicle by registering the wheel button pressure count applied on said guiding pin as the wheel button gets in contact with said object.

12. The method as claimed in claim 1, wherein said at least one marketing unit that provides an order for dispensing said delivery unit filled with the required goods can be one of: a retailer shop, a wholesale market, a trading unit, a sales unit.

13. The method as claimed in claim 1, wherein said delivery unit filled with the required goods based on the order provided by said at least one marketing unit can be considered as said placer robot for dispensing said at least one item based on the order provided by said at least one consumer over said network.

14. The method as claimed in claim 13, wherein in said placer robot is configured to extract said delivery unit, filled with said at least one item, from said delivery vehicle and dispense said at least one item from said delivery unit based on an order provided by said at least one consumer.

15. The method as claimed in claim 1, wherein said delivery vehicle is scanned by a laser signal for extracting a unique identifier associated with said delivery vehicle that can uniquely identify said delivery vehicle.

16. A system for enhancing an automated delivery system for at least one consumer by implementing a laser scanning mechanism, wherein said system is configured to:
receive an order provided by at least one consumer over a network;
dispense at least one item in a delivery vehicle based on the order provided by said at least one consumer;
count the number the objects provided over a guideway track to stop said delivery vehicle at the required location based on the order provided by said at least one consumer;
collect said at least one item that is dispensed from at least one placer robot in said delivery vehicle, after said delivery vehicle stops at the required location over said guideway track; and
dispense a delivery unit filled with the required item(s) based on the order provided by at least one marketing unit.

17. The system as claimed in claim 16, wherein said system is configured to implement said laser scanning mechanism to dispense said at least one item in said delivery vehicle by:
stopping said delivery vehicle, that is in motion over said guideway, near said at least one placer robot by identifying a laser emitting device located near said at least one placer robot;
detecting said delivery vehicle that has stopped near said at least one placer robot by using at least one motion detector;
signaling said laser emitting device to produce laser for scanning said delivery vehicle;
identifying said delivery vehicle based on the laser scanning performed; and
instructing said placer robot to release said at least one item that has been ordered by said at least one consumer over said network.

18. The system as claimed in claim 16, wherein said system is configured to implement said laser scanned counting mechanism to stop said delivery vehicle at the required location for collecting said at least one item by:
identifying an object by said delivery vehicle placed in said guideway for recording a count on the number of objects that has been passed by said delivery vehicle; and
instructing said delivery vehicle to stop immediately after said delivery vehicle has crossed the number of objects programmed by said laser scanned counting mechanism.

19. The system as claimed in claim 16, wherein said system is configured to instruct said at least one consumer to design an item holder within said delivery unit of said delivery vehicle by considering said at least one container's size, shape, layout to be placed in at least one drawer to collect said at least one item that is dispensed from said placer robot.

20. The system as claimed in claim 19, wherein said delivery unit can be structured in the form of said at least one drawer or a box cart to collect said at least one item that is dispensed from said placer robot.

21. The system as claimed in claim 20, wherein said at least one drawer of said delivery vehicle can be positioned to slide out of said delivery vehicle from side-ways or from a rear-side of said delivery vehicle.

22. The system as claimed in claim 19, wherein said system is configured to implement a locking and unlocking mechanism for said at least one drawer of said delivery vehicle while delivering said at least one item ordered by said at least one consumer.

23. The system as claimed in claim 22, wherein said system is configured to instruct said at least one consumer to implement said locking and unlocking mechanism on a display screen of said at least one consumer's device.

24. The system as claimed in claim 19, wherein said item holder can be designed by connecting a plurality of said at least one container through an accordion connector.

25. The system as claimed in claim 18, wherein identifying said object to record the count on the number of objects that has been passed by said delivery vehicle comprises of a guiding pin and a wheel button.

26. The system as claimed in claim 25, wherein said system is configured to determine the count on the number of objects that has been passed by said delivery vehicle by registering the wheel button pressure count applied on said guiding pin as the wheel button gets in contact with said object.

27. The system as claimed in claim 16, wherein said at least one marketing unit that provides an order for dispensing said container filled with the required goods can be one of: a retailer shop, a wholesale market, a trading unit, a sales unit.

28. The system as claimed in claim 16, wherein said delivery unit filled with the required goods based on the order provided by said at least one marketing unit can be considered as said placer robot for dispensing said at least one item based on the order provided by said at least one consumer over said network.

29. The system as claimed in claim 28, wherein in said at least one placer robot is configured to extract said delivery unit from said delivery vehicle and dispense said at least one item from said delivery unit based on the order provided by said at least one consumer.

30. The system as claimed in claim 16, wherein said delivery vehicle is scanned by a laser signal for extracting a unique identifier associated with said delivery vehicle that can uniquely identify said delivery vehicle.

31. The system as claimed in claim 29, wherein said delivery unit filled with the required item(s) based on the order provided by said at least one marketing unit can be referred to as said at least one placer robot that is used for dispensing said at least one item based on the order provided by said at least one consumer over said network.
